(19) United States
(12) Patent Application Publication
(10) Pub. No.: US 2008/0314818 A1
(43) Pub. Date: Dec. 25, 2008

(54) PRESSING METHOD, PUNCHING PLATE, AND LIQUID EJECTING HEAD

(75) Inventors: Shinichi TONAMI, Matsumoto-shi (JP); Narimitsu SAITO, Sakata-shi (JP); Koichi SAITO, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/145,372

(22) Filed: Jun. 24, 2008

(30) Foreign Application Priority Data
Jun. 25, 2007 (JP) 2007-165924

(51) Int. Cl. B01D 29/00

(52) U.S. Cl. 210/348; 72/333

(57) ABSTRACT

A pressing method by which through holes are formed using a punch in a target plate material that has a first face and a second face that is opposite to the first face, includes forming at least one first through hole by punching the target plate material from the second face with the punch in such an orientation that the first face of the target plate material is in contact with a base that is made of an elastic material, and forming at least one second through hole from the first face of the target plate material in a region, which is different from a region in which the at least one first through hole is formed, in such an orientation that the second face of the target plate material is in contact with the base.

### CROSS-REFERENCE TO RELATED APPLICATIONS

This application claims the benefit of priority to Japanese Patent Application No. 2007-165924 filed Jun. 25, 2007, the contents of which are hereby incorporated by reference in their entirety.

### BACKGROUND

1. Technical Field

The present invention relates to a pressing method, a punching plate, and a liquid ejecting head and, more particularly, to a pressing method suitable for forming a fine through hole, a pressed punching plate, and a liquid ejecting head that uses the pressed punching plate.

2. Related Art

For example, a filter is used for filtering liquid in the flow passage of a liquid ejecting head that discharges liquid droplets from nozzle openings by generating pressure variation in liquid in pressure chambers, and the filter is configured so that a plurality of fine diameter through holes are formed in a thin metal plate (for example, a stainless plate). The method for forming the through holes in the metal plate includes a method by means of etching, and a pressing method (plastic forming) using a die.

In the case of the pressing, generally, a metal plate, which serves as a target plate material, is mounted on a die (female die), in which punch holes are formed at positions corresponding to the through holes that will be formed, and, in the above mounted situation, punches (male die) are pushed in from the surface of the metal plate toward the punch holes of the die to thereby form the through holes, which is, for example, described in JP-A-05-169148.

When fine through holes of orders of μm are formed by the above existing pressing method, it is difficult to ensure the rigidity of each punch having a narrow diameter, and, in addition, a clearance between each punch and the die is small. Thus, there has been a possibility that the punches may contact the die and, hence, the punches may be broken, or the like, if the accuracy of relative positions is poor. In addition, when a thin metal plate is pressed in the existing method, there has been a problem that the metal plate will warp because of a biased residual stress.

### SUMMARY

An advantage of some aspects of the invention is that it provides a pressing method, a punching plate, and a liquid ejecting head, which are able to form a fine through hole while ensuring the durability of a punch, and also able to suppress warpage without providing any additional processes.

An aspect of the invention provides a pressing method by which through holes are formed in a target plate material using a punch. The target plate material has a first face and a second face that is opposite to the first face. The pressing method includes forming at least one first through hole by punching the target plate material from the second face with the punch in such an orientation that the first face of the target plate material is in contact with a base that is made of an elastic material, and forming at least one second through hole from the first face of the target plate material in a region, which is different from a region in which the at least one first through hole is formed, in such an orientation that the second face of the target plate material is in contact with the base.

According to the above configuration, because the at least one first through hole is formed by punching the target plate material with the punch from the second face that is opposite to the first face in such an orientation that the first face of the target plate material is in contact with the base made of an elastic material, and the at least one second through hole is formed from the first face in the region that is different from the region in which the at least one first through hole is formed in such an orientation that the second face is in contact with the base, it is not necessary to use a female die (die). Thus, it is possible to easily form fine through holes while ensuring the durability of the punch. In addition, because the through holes are formed by punching the target plate material from both sides thereof with the punch, without providing an additional process for correcting warpage of the target plate material, it is possible to cancel a stress (residual stress) applied to the target plate material to thereby make it possible to suppress warpage of the target plate material.

In the above configuration, the number of the first through holes formed may be different from the number of the second through holes formed.

According to the above configuration, only by differentiating the number of through holes formed, it is possible to easily adjust the warpage of the target plate material.

In addition, in the above configuration, when the target plate material is punched with the punch, depressed portions, which are curved toward a direction in which the first and second through holes are punched to sink downward in the form of funnel as they approach peripheries of the first and second through holes, may be formed at peripheral portions around the first and second through holes that are formed in the target plate material in such a manner that peripheral portions around the first and second through holes in the target plate material are pushed in toward a deeper side in a thickness direction of the base against an elastic force of the base and are deformed.

According to the above configuration, because the depressed portions, which are curved in the direction in which the first and second through holes are punched to sink downward in the form of funnel as they approach the peripheries of the first and second through holes, are formed at the peripheral portions around the first and second through holes that are formed in the target plate material, the first face sides of these depressed portions are formed to protrude in the shape of a smooth hill. Thus, a burr is hardly separated unlike the case of the existing burr. As a result, it is possible to reduce the inconvenience due to burrs.

In the above configuration, a direction in which a depressed portion of the at least one first through hole is depressed and a direction in which a depressed portion of the at least one second through hole is depressed may be opposite from each other.

In addition, in the above configuration, after the target plate material has been punched, the punch may be further pushed in toward a deeper side in a thickness direction of the base against an elastic force of the base. Furthermore, a stripper that has been punched with the punch may be left and held in a recess that is pushed and then formed on a surface of the base.

According to the above configuration, after the target plate material has been punched, by further pushing the punch in toward a deeper side in the thickness direction of the base against an elastic force of the base, a stripper that has been punched with the punch may be left and held in the recess that is pushed and then formed on the surface of the base. Thus, it is not necessary to provide an additional process for collecting strippers and, hence, it is easy.

In the above configuration, an amount by which the punch pushes in from a surface of the target plate material into the base may be twice or above the thickness of the target plate material.

According to the above configuration, it is possible to completely separate strippers, when the target plate material is punched, from the target plate material and push the strippers into the base.

In addition, in the pressing method according to the aspect of the invention, the target plate material may be a stainless plate.

Another aspect of the invention provides a punching plate. The punching plate has a first face and a second face that is opposite to the first face. The punching plate includes at least one first through hole that is formed by punching the target plate material from the second face with the punch in such an orientation that the first face of the target plate material is in contact with a base that is made of an elastic material, at least one second through hole that is formed from the first face of the target plate material in a region, which is different from a region in which the at least one first through hole is formed, in such an orientation that the second face of the target plate material is in contact with the base, and depressed portions, which are curved toward a direction in which the first and second through holes are punched to sink downward in the form of funnel as they approach peripheries of the first and second through holes and which are formed at peripheral portions around the first and second through holes that are formed in the target plate material in such a manner that peripheral portions around the first and second through holes in the target plate material are pushed in toward a deeper side in a thickness direction of the base against an elastic force of the base and are deformed, when the target plate material is punched with the punch.

According to the above configuration, because the at least one first through hole is formed by punching the target plate material with the punch from the second face that is opposite to the first face in such an orientation that the first face of the target plate material is in contact with the base that is made of an elastic material, and the at least one second through hole is formed from the first face in the region that is different from the region in which the at least one first through hole is formed in such an orientation that the second face is in contact with the base, it is not necessary to use a female die. Thus, it is possible to form fine through holes while ensuring the durability of the punch. In addition, because the through holes are formed by punching the target plate material from both sides thereof with the punch, it is possible to cancel a stress applied to the target plate material to thereby make it possible to suppress the warpage of the target plate material. Furthermore, because the depressed portions, which are curved in the direction in which the first and second through holes are punched to sink downward in the form of funnel as they approach the peripheries of the first and second through holes, are formed in the peripheral portions around the first and second through holes that are formed in the target plate material, on the rear side, the peripheral portions around these through holes are formed to protrude in the shape of a smooth hill. Thus, a burr is hardly separated unlike the case of the existing burr. As a result, it is possible to reduce the inconvenience due to burrs.

In the above configuration, the number of the first through holes formed may be different from the number of the second through holes formed.

According to the above configuration, only by differentiating the number of the first through holes formed from the number of the second through holes formed, it is possible to easily adjust the warpage.

In addition, in the above configuration, a direction in which a depressed portion of the at least one first through hole is depressed and a direction in which a depressed portion of the at least one second through hole is depressed may be opposite from each other. In addition, yet another aspect of the invention provides a punching plate. The punching plate has through holes that are formed in a target plate material. The through holes may include at least one through hole of which a peripheral portion has a funnel-shaped depressed portion that is curved as it approaches a periphery of the at least one first through hole and at least one second through hole of which a peripheral portion has a funnel-shaped depressed portion that is curved as it approaches a periphery of the at least one second through hole. A direction in which the depressed portion of the at least one first through hole is depressed and a direction in which the depressed portion of the at least one second through hole is depressed is opposite from each other.

In addition, further another aspect of the invention provides a liquid ejecting head. The liquid ejecting head has a series of liquid flow passage that extends from a liquid supply source to a nozzle opening. The liquid ejecting head ejects liquid from the nozzle opening by driving a pressure generating source. The liquid ejecting head includes a filter in which a plurality of through holes are formed by means of the above configured pressing method and which is arranged along the liquid flow passage. Liquid that flows in the liquid flow passage is filtered by the filter. In addition, further another aspect of the invention provides a liquid ejecting head. The liquid ejecting head has a series of liquid flow passage that extends from a liquid supply source to a nozzle opening. The liquid ejecting head ejects liquid from the nozzle opening by driving a pressure generating source. The above described punching plate is arranged as a filter along the liquid flow passage. Liquid that flows in the liquid flow passage is filtered by the filter.

### BRIEF DESCRIPTION OF THE DRAWINGS

The invention will be described with reference to the accompanying drawings, wherein like numbers reference like elements.

FIG. 1 is a cross-sectional view of a relevant part that illustrates the configuration of a recording head.

FIG. 2 is a cross-sectional view of a relevant part that illustrates the configuration of a press mechanism.

FIG. 3A to FIG. 3C are cross-sectional views that illustrate processes for forming a through hole in a base plate.

FIG. 4A is a cross-sectional view that illustrates a process for forming first through holes, and FIG. 4B is a cross-sectional view that illustrates a process for forming second through holes.

FIG. 5 is a cross-sectional view of a relevant part of a filter.

### DESCRIPTION OF EXEMPLARY EMBODIMENTS

Hereinafter, an embodiment that implements the invention will be described with reference to the accompanying drawings. Note that, in the following embodiment, various limitations will be described as specific examples of the invention; however, the scope of the invention is not intended to be limited to these embodiments unless otherwise stated. In addition, in the following description, a filter 3 that is used for an ink jet recording head (one of liquid ejecting heads, and hereinafter, simply referred to as recording head) and that is mounted on an ink jet recording apparatus (hereinafter, simply referred to as printer) is exemplified as a target plate material or a punching plate according to the aspects of the invention.

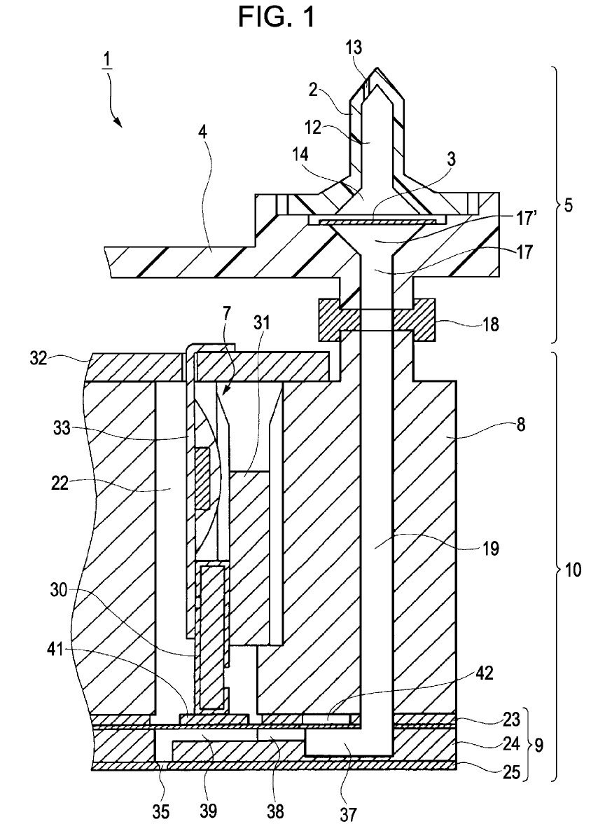

First, the configuration of the recording head will be described. FIG. 1 is a cross-sectional view of a relevant part that illustrates the configuration of the recording head 1 according to the present embodiment. The exemplified recording head 1 schematically includes a filter assembly 5 and a head unit 10. The filter assembly 5 is formed of an ink introducing needle 2, the filter 3, an introducing needle unit 4, and the like. The head unit 10 includes a vibrator unit 7, a head case 8, a flow passage unit 9, and the like. Inside this recording head 1, a series of ink flow passage (a kind of liquid flow passage) is formed from a liquid supply source to a nozzle opening.

The ink introducing needle 2 (liquid introducing needle) is, for example, a hollow, needle-like member that is made of a synthetic resin, such as epoxy resin. The internal space of the ink introducing needle 2 is a needle flow passage 12 into which ink (a kind of liquid or fluid) contained in a liquid storage member (liquid storage source), such as an ink cartridge or a sub tank (self-sealing valve), is introduced. An introducing hole 13 is formed at the distal end portion of the ink introducing needle 2 and is in fluid communication with the needle flow passage 12. As the ink introducing needle 2 is inserted into the liquid storage member, ink in the liquid storage member is introduced through the introducing hole 13 into the needle flow passage 12. In addition, the proximal end portion of the ink introducing needle 2 is formed into an increased diameter portion 14 that increases its diameter from the upstream side (distal end side) toward the downstream side (introducing needle unit 4 side). The increased diameter portion 14 has the function of temporarily trapping air bubbles (a kind of fluid) generated in the ink flow passage. Then, the filter 3 is arranged near the downstream side opening of the increased diameter portion 14, that is, near the downstream side opening of the ink introducing needle 2, and filters ink that is introduced into the needle flow passage 12. The details of the filter 3 will be described later.

The introducing needle unit 4, as well as the ink introducing needle 2, is made of a synthetic resin, such as epoxy resin. Inside the introducing needle unit 4, an ink supply passage 17 corresponding to each ink introducing needle 2 is formed. Then, the ink introducing needle 2 is attached to the introducing needle unit 4 in a state where the filter 3 is fixed to the peripheral portion of an inlet opening 17′ of the ink supply passage 17. That is, the ink supply passage 17 is in fluid communication with the needle flow passage 12 in a fluid-tight manner. In addition, the downstream end of the ink supply passage 17 is in fluid communication with a case flow passage 19, which is formed inside the head case 8, through a flow passage joint member 18 (packing) in a fluid-tight manner. In this manner, ink is introduced from the introducing hole 13 of the ink introducing needle 2 and is filtered by the filter 3. After that, the ink is supplied through the ink supply passage 17 to the head unit 10 side.

The head case 8 is a casing that accommodates the vibrator unit 7. Thus, the head case 8 has an accommodation space 22 formed therein. The accommodation space is able to accommodate the vibrator unit 7. Then, the vibrator unit 7 is inserted in the accommodation space 22 and is fixed to the inner wall of the accommodation space 22 by adhesive or the like. The one face of the head case 8 is connected to the introducing needle unit 4, so that the case flow passage 19 is in fluid communication with the ink supply passage 17 of the introducing needle unit 4 in a liquid-tight manner. In addition, the flow passage unit 9 is fixed to the other face of the head case 8 by adhesive or the like. The flow passage unit 9 is formed in such a manner that a diaphragm 23, a flow passage forming substrate 24 and a nozzle plate 25 are connected by adhesive or the like so as to be integrated in a state where they are laminated.

The vibrator unit 7 includes piezoelectric vibrators 30, a fixed plate 31, a circuit board 32, flexible cables 33, and the like. The piezoelectric vibrators 30 each serve as a pressure generating source. Each piezoelectric vibrator 30 is connected to the fixed plate 31. The circuit board 32 supplies a driving signal to each of the piezoelectric vibrators 30. Each of the flexible cables 33 electrically connects the circuit board 32 with a corresponding one of the piezoelectric vibrators 30. The piezoelectric vibrators 30 according to the present embodiment are formed of a plurality of the piezoelectric vibrators 30 that are provided in a column in a comb-like shape. Each piezoelectric vibrator 30 has a fixed end portion that is connected to the fixed plate 31 and a free end portion that protrudes outside from the distal end face of the fixed plate 31. That is, each piezoelectric vibrator 30 is attached to the fixed plate 31 in a state of a so-called cantilever. In addition, the fixed plate 31 that supports the piezoelectric vibrators 30 is, for example, formed of stainless steel having a thickness of about 1 mm. Note that the pressure generating source may employ an electrostatic actuator, a magnetostrictive element, a heater element, or the like, other than the above piezoelectric vibrator.

The nozzle plate 25 that is arranged at the bottom of the flow passage unit 9 is a metal thin plate material in which the plurality of nozzle openings 35 are formed in a column at a pitch (for example, 180 dpi) corresponding to the density in which dots are formed. The nozzle plate 25 of the present embodiment is formed of a stainless plate material, and a plurality of the columns (nozzle columns) of the nozzle openings 35 are provided and aligned along the scanning direction of the recording head 1. Then, one nozzle column is, for example, formed of 180 nozzle openings 35.

The flow passage forming substrate 24 is arranged between the nozzle plate 25 and the diaphragm 23. The flow passage forming substrate 24 is a plate-like member in which a flow passage base portion, which serves as an ink flow passage, is defined, that is, more specifically, spaces that serve as a common ink chamber 37 that is a kind of a common liquid chamber, ink supply ports 38 and pressure chambers 39 are defined. In the present embodiment, the flow passage forming substrate 24 is formed by performing anisotropic etching on a silicon wafer, which is a kind of crystalline base material.

The diaphragm 23 is arranged between the flow passage forming substrate 24 and the head case 8. The diaphragm 23 is a double layer structure composite plate material in which an elastic film is laminated on a support plate made of metal, such as stainless steel. In the diaphragm 23, island portions 41 for bonding the distal ends of the free end portions of the piezoelectric vibrators 30 are formed at portions corresponding to the pressure chambers 39 by means of etching, or the like, and the above portions function as diaphragm portions. That is, the diaphragm 23 is configured so that elastic films around the island portions 41 elastically deform in accordance with the action of the piezoelectric vibrators 30. In addition, the diaphragm 23 seals the open face of the common ink chamber 37 of the flow passage forming substrate 24 and also serves as a compliance portion 42 as well. A portion of the diaphragm 23 corresponding to the compliance portion 42, as well as the diaphragm portions, is only formed of the elastic film by removing the support plate by means of etching, or the like.

Then, in the recording head 1, as a driving signal is supplied from the circuit board 32 through the flexible cable 33 to the piezoelectric vibrator 30, the piezoelectric vibrator 30 extends or contracts in the longitudinal direction of the element, and, in accordance with this, the island portion 41 moves in a direction to approach the pressure chamber 39 or moves in a direction away from the pressure chamber 39. In this manner, the volume in the pressure chamber 39 varies and, thereby, pressure variation occurs in ink contained in the pressure chamber 39. Owing to the pressure variation, ink droplets are discharged (ejected) from the nozzle opening 35.

Here, the filter 3 will be described. The filter 3 is configured so that a large number of fine through holes which have a diameter of about a dozen of μm to several tens of μm and through which ink or bubbles can pass are formed in a metal circular plate material (for example, stainless plate). The thickness of the filter 3 (a base plate 3′, which is formed into the filter 3) and the inner diameter of each through hole both are 15 μm in the present embodiment. Note that the thickness of the base plate 3′ is desirably a value within the same range as the range of the dimension of the inner diameter of each through hole. When such fine through holes are formed in a metal plate using the existing pressing method, because a clearance between a male die and a female die is small, there has been a possibility that breakage (buckling, or the like) of the die may occur if the accuracy of relative position is poor. In addition, there has been a possibility that inconvenience such that a burr is formed around the perforated through holes and, then, the burr (a fragment of burr) peels off and is mixed into ink in the flow passage to thereby block the flow passage may occur.

Thus, in the present embodiment, the above inconvenience is removed by manufacturing the filter 3 using a pressing method according to the aspects of the invention.

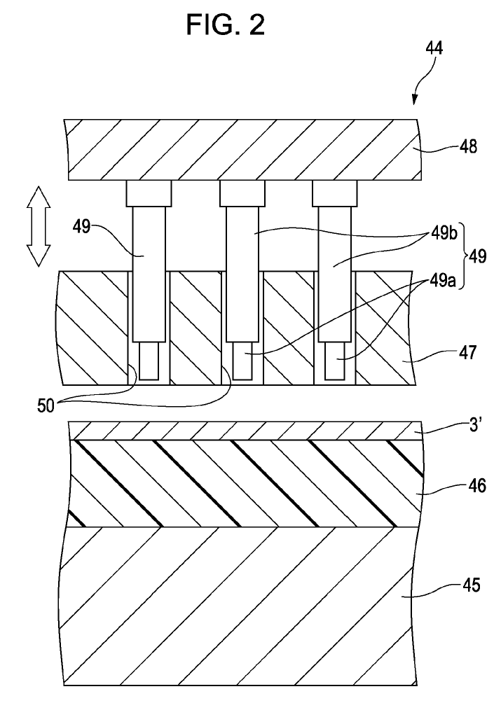

FIG. 2 is a cross-sectional view of a relevant part that illustrates the configuration of a press mechanism 44 for forming the through holes in the base plate 3′, which serves as the filter 3. The exemplified press mechanism 44 includes a mount (stool) 45, an elastic mat 46 (which may be regarded as a base according to the aspects of the invention), a stripper plate 47, a punch holder 48, punches 49, and the like. The stripper plate 47 is attached to the punch holder 48 in a state of being urged downward by a stripper bolt (not shown) around which an urging member, such as a coil spring, is wound, that is, in a state of being urged toward the mount 45 so that the stripper plate 47 is operable to approach or leave the punch holder 48. The stripper plate 47 has guide holes 50, each having a circular cross section, that are set to have an inner diameter slightly larger than the outer diameter of a body portion 49b of each punch 49. The plurality of punches 49 are attached to the punch holder 48 in a state where the body portions 49b are inserted in the guide holes 50 of the stripper plate 37 and the punch distal ends 49a are directed downward. The punch holder 48 is configured to be able to move up and down relative to the mount 45.

The elastic mat 46 is arranged on the upper face of the mount 45 and contacts and supports the base plate 3′ (which may be regarded as a target plate material according to the aspects of the invention), which serves as the filter 3. The elastic mat 46 is a plate material made of a material having elasticity, such as polyethylene terephthalate (PET) or elastomer, and is set to have a thickness of about twenty times the thickness of the base plate 3′. Then, when through holes are formed in the base plate 3′, the process is performed in a state where the base plate 3′ is mounted on the elastic mat 46. That is, the pressing method according to the aspects of the invention employs a so-called dieless press.

The through hole forming process includes a first process in which first through holes 52a are formed and a second process in which second through holes 52b are formed. In the present embodiment, the first process is initially performed and then the second process is performed.

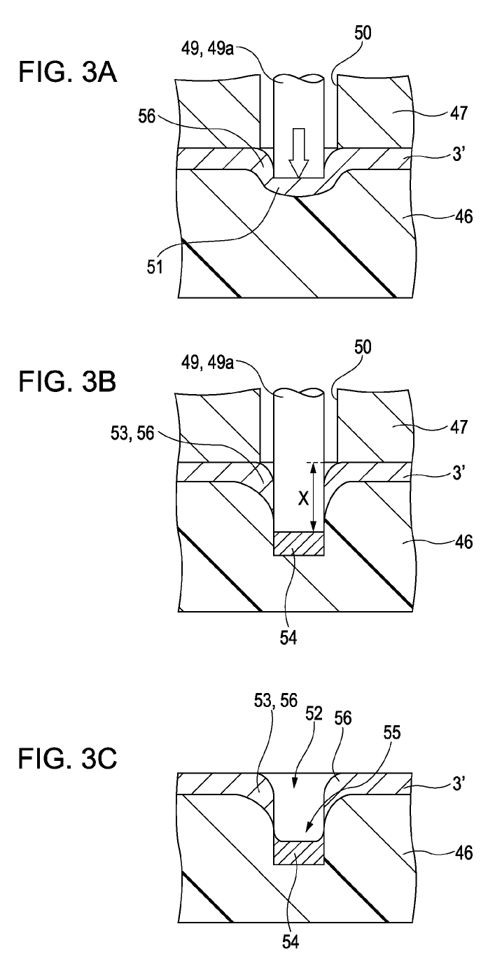

In the first process, the base plate 3′ is mounted on the elastic mat 46 and then the rear face (first face) of the base plate 3′ is brought into contact with the elastic mat 46. Thereafter, the base plate 3′ and the elastic mat 46 are placed on the mount 45. Note that, although not shown in the drawing, a correction frame is attached at the outer periphery of the base plate 3′, and a tension is applied in the planar direction of the base plate 3′ by this correction frame so that the entire face of the base plate 3′, when the base plate 3′ is being processed, contacts the elastic mat 46 without any warpage. Then, in this state, the punch holder 48 is lowered toward the elastic mat 46. Thereafter, first, the lower face of the stripper plate 47 contacts the surface (second face) of the base plate 3′. After that, as the punch holder 48 is further pushed downward against the urging force of the coil spring, the punches 49 (the punch distal ends 49a) are pushed in from the front face side of the base plate 3′ toward the rear face side thereof, as shown in FIG. 3A, while the punches 49 are being guided by the guide holes 50 of the stripper plate 47. At this time, each of the punches 49 advances into the base plate 3′ while fluidizing a portion of the material of the base plate 3′. A portion of the base plate 3′ that receives a pressing force from the punch 49 is pushed out to the rear face side of the base plate 3′ against the elastic force of the elastic mat 46 to thereby become a bulged portion 51.

Then, the punches 49 are further pushed in toward the elastic mat 46 to punch the base plate 3′. At this time, portions that will be the through holes 52 and their peripheral portions in the base plate 3′ are pushed in toward the deeper side in the thickness direction of the elastic mat 46 and are deformed. Thus, a peripheral portion 53 around each through hole 52 is curved to sink downward from the front face of the base plate 3′ toward the rear face side (in the punched direction) in the form of funnel as it approaches the periphery of the through hole 52. A portion at which the peripheral portion 53 smoothly sinks downward will be a depressed portion 56. The rear face side of the depressed portion 56 is formed to protrude in the shape of a smooth hill (crater). That is, a clearance is formed between the existing punches and the die, but there is no clearance between the elastic mat 46 and the punches 49. In addition, the peripheral portions 53 are deformed by being pushed by the punches 49 into the elastic mat 46 against the elasticity of the elastic mat 46. Thus, a sharply bent portion with respect to the base plate is not formed unlike a burr of the existing art.

Next, as shown in FIG. 3B, after the base plate 3′ is punched by the punches 49, the punches 49 are further pushed in toward the deeper side in the thickness direction of the elastic mat 46 against the elastic force of the elastic mat 46. At this time, a distance from the front face of the base plate to the bottom dead center, that is, an amount X by which the punches 49 are pushed into the elastic mat, is desirably twice or above the thickness of the base plate 3′. In this manner, strippers 54, when punched with the punches 49, are completely separated from the base plate 3′ and are pushed into the elastic mat 46.

After that, the punch holder 48 is raised. Then, when the stripper plate 47, which is urged downward, is in press contact with the base plate 3, the punches 49 are pulled out from the base plate 3′. Thereafter, as the punch holder 48 returns to the top dead center, the stripper plate 47 leaves the base plate 3′. Then, as shown in FIG. 3C, a stripper 54 is left and held in a recess 55 that is pressed to be formed on the surface of the elastic mat 46. Thus, it is not necessary to additionally provide a process to collect the strippers 54 and, therefore, it is simple.

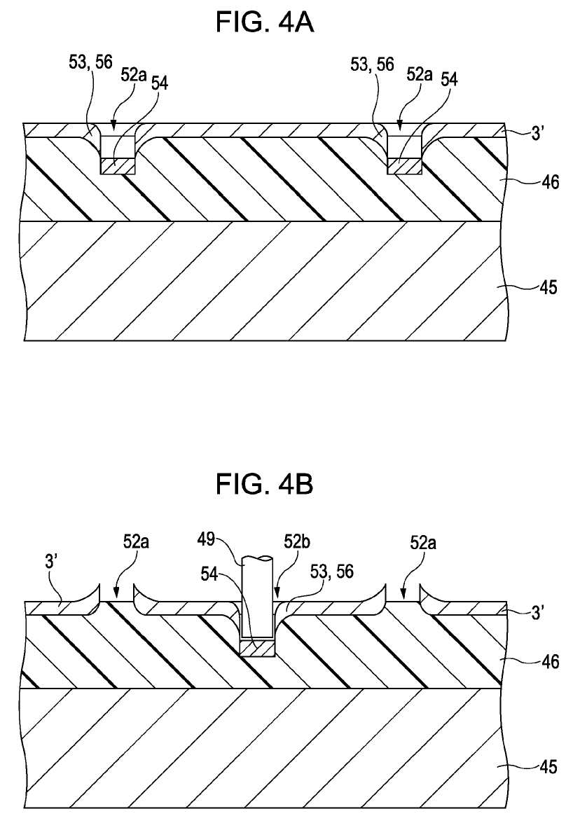

In this manner, as shown in FIG. 4A, the first through holes 52a are formed in the base plate 3′ at a pitch that is twice the pitch at which the through holes 52 are intended to be finally arranged. Note that, at the time when only the first through holes 52a are formed, warpage of the base plate 3′ tends to occur because of a biased residual stress.

When the first process has been completed, the second process will be initiated subsequently. As shown in FIG. 4B, in the second process, the base plate 3′ is turned upside down on the elastic mat 46, and the front face (second face) is brought into contact with the elastic mat 46. Then, in this state, the second through holes 52b are formed at regions different from the regions, in which the first through holes 52a are formed, by punching the base plate 3′ from the rear face (first face) with the punches 49. Thus, the first through holes 52a and the second through holes 52b are alternately formed at a predetermined pitch in the base plate 3′. Note that, in the present embodiment, the number of the first through holes 52a formed and the number of the second through holes 52b formed are made equal; however, it is not limited. It is possible to differentiate the number of the first through holes 52a formed from the number of the second through holes 52b formed depending on the state of warpage of the base plate 3′. In this manner, only by differentiating the number of through holes formed, it is possible to easily adjust the warpage of the base plate 3′.

As well as the first through holes 52a, in regard to each of the second through holes 52b, a depressed portion 56 is formed at the peripheral portion 53 so that it is curved to sink downward in the punched direction in the form of funnel as it approaches the periphery of the through hole 52b. In other words, on the front face side of the base plate 3′, portions corresponding to the depressed portions 56 are formed to protrude in the shape of a crater. Thus, the direction in which the depressed portions 56 of the first through holes 52a are depressed and the direction in which the depressed portions 56 of the second through holes 52b are depressed are opposite from each other. Finally, a finished product, which has been punched in a predetermined shape (for example, circular shape) and a predetermined size, will become the filter 3 used for the recording head 1.

In the present embodiment, the distance between any adjacent through holes 52a and 52b (pitch between the holes) in the filter 3 is set twice or above the inner diameter of each through hole 52. Thus, a flat, undented region is sufficiently ensured between any adjacent through holes 52. Therefore, between the adjacent through holes 52, it is possible to suppress the situation that fluidization of the material of the base plate 3′, when the second through holes 52b, which are formed after the first through holes 52a, are processed, influences the first through holes 52a, which are formed before the second through holes 52b, (for example, deformation of the through holes 52, or the like) to the minimum degree.

According to the above pressing method, because the first through holes 52a are formed by punching the base plate 3′ from the front face (second face) with the punches 49 in a state where the rear face (first face) of the base plate 3′ is in contact with the elastic mat 46 and then the second through holes 52b are formed in regions different from the regions, in which the first through holes 52a are formed, by punching the base plate 3′ from the rear face (first face) with the punches 49 in a state where the front face of the base plate 3′ is in contact with the elastic mat 46, it is not necessary to use a female die (die) that is used in the existing pressing process. Thus, it is possible to form the fine through holes 52 while ensuring the durability of the punches 49. In addition, because the elastic mat 46 is used in place of a female die of the existing art, it is possible to simplify a processing equipment, such as a die, and, hence, it is possible to reduce the cost of die.

In addition, because the through holes 52a and 52b are formed by punching the base plate 3′ from both sides thereof with the punches 49, without providing an additional process for correcting warpage of the base plate 3′, it is possible to cancel a stress (residual stress) applied to the base plate 3′ to thereby make it possible to suppress warpage of the base plate 3′ (filter 3). In this manner, it is possible to provide the filter 3 that is less warped and, therefore, it is easy to attach the filter 3 to the recording head 1.

In addition, because the depressed portions 56, which are curved in the direction in which the through holes 52 are punched to sink downward in the form of funnel as they approach the periphery of the through holes 52, are formed by deforming the peripheral portions 53 around the through holes 52 formed in the base plate 3′, the rear face side of each depressed portion 56 is formed to protrude in the shape of a smooth crater (hill). Thus, a burr is hardly separated unlike the case of the existing burr (a portion that protrudes in a state of being sharply bent with respect to the base plate). As a result, it is possible to reduce the inconvenience due to burrs. For example, in the case of the recording head 1 having the filter 3, it is possible to prevent inconvenience, such as the case in which burrs are mixed into ink in the ink flow passage to block the flow passage or the case in which burrs are discharged together with ink from the nozzle openings 35 and adhere on a recording sheet of paper, or the like.

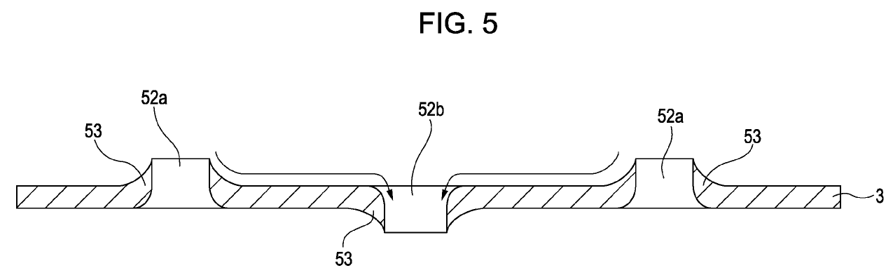

Then, in the filter 3 of the recording head 1, because the direction in which the depressed portions 56 of the first through holes 52a are depressed and the direction in which the depressed portions 56 of the second through holes 52b are depressed are opposite from each other, as shown in FIG. 5, there is a different in level between the protruded end of the peripheral portion 53 around each through hole 52a and the protruded end of the peripheral portion 53 around each through hole 52b. Thus, it is possible to smoothly flow ink using the difference in level (arrow shown in FIG. 5). In addition, because the surface of the filter 3 becomes uneven owing to the protrusion of the peripheral portion 53 around each through hole 52, bubbles hardly adhere on the surface of the filter 3 at the flow rate of ink in a normal recording operation (ejecting operation). Thus, it is possible to prevent inconvenience, such as the case in which bubbles block the filter 3 and therefore the amount of ink supply becomes insufficient. Furthermore, in a cleaning operation in which ink, bubbles, or the like, that is thickened in the flow passages of the recording head 1, is forcibly drained from the nozzle openings 35, bubbles, trapped in the increased diameter portion 14 upstream of the filter 3, as well as ink, may also smoothly flow and drain through the through holes 52 of the filter 3 to the downstream side. Particularly, because bubbles easily contact the peripheral portions 53 of the through holes 52, protruding toward the upstream side of the filter 3, it is possible to actively drain bubbles from the above through holes 52. In this manner, it may be expected to improve the efficiency of draining bubbles.

Note that, in the above described embodiment, the process in which the first through holes 52a are formed and the process in which the second through holes 52b are formed are separately performed; however, it is not limited to this. For example, it is applicable that, by punching the base plate 3′ from both sides (upper side and lower side) thereof with the punches at the same time in a state where both faces of the base plate 3′ are in contact with the elastic mat 46, the first through holes 52a and the second through holes 52b are formed at the same time.

Note that, in the above description, the filter 3 used for the recording head 1, which is a kind of liquid ejecting head, is described as a punching plate that is formed by means of the pressing method according to the aspects of the invention; however, the aspects of the invention may also be applied to a punching plate used for another application. In addition, the pressing method according to the aspects of the invention is not limited to the punching plate, but it may be desirably applied to the case in which fine through holes of orders of μm are formed in a thin metal plate material, or the like. In addition, the shape of each through hole is not limited to a circular shape. For example, the shape may be rectangular, or the like.

What is claimed is:

1. A pressing method by which through holes are formed using a punch in a target plate material that has a first face and a second face that is opposite to the first face, the pressing method comprising:
forming at least one first through hole by punching the target plate material from the second face with the punch in such an orientation that the first face of the target plate material is in contact with a base that is made of an elastic material; and
forming at least one second through hole from the first face of the target plate material in a region, which is different from a region in which the at least one first through hole is formed, in such an orientation that the second face of the target plate material is in contact with the base.

2. The pressing method according to claim 1, wherein the number of the first through holes formed is different from the number of the second through holes formed.

3. The pressing method according to claim 1, wherein, when the target plate material is punched with the punch, depressed portions, which are curved toward a direction in which the first and second through holes are punched to sink downward in the form of funnel as they approach peripheries of the first and second through holes, are formed at peripheral portions around the first and second through holes that are formed in the target plate material in such a manner that peripheral portions around the first and second through holes in the target plate material are pushed in toward a deeper side in a thickness direction of the base against an elastic force of the base and are deformed.

4. The pressing method according to claim 3, wherein a direction in which a depressed portion of the at least one first through hole is depressed and a direction in which a depressed portion of the at least one second through hole is depressed are opposite from each other.

5. The pressing method according to claim 1, wherein, after the target plate material has been punched, the punch is further pushed in toward a deeper side in a thickness direction of the base against an elastic force of the base.

6. The pressing method according to claim 5, wherein a stripper that has been punched with the punch is left and held in a recess that is pushed and then formed on a surface of the base.

7. The pressing method according to claim 5, wherein an amount by which the punch pushes in from a surface of the target plate material into the base is twice or above the thickness of the target plate material.

8. The pressing method according to claim 1, wherein the target plate material is a stainless plate.

9. A punching plate, which has a first face and a second face that is opposite to the first face, comprising:
at least one first through hole that is formed by punching the target plate material from the second face with the punch in such an orientation that the first face of the target plate material is in contact with a base that is made of an elastic material;
at least one second through hole that is formed from the first face of the target plate material in a region, which is different from a region in which the at least one first through hole is formed, in such an orientation that the second face of the target plate material is in contact with the base; and
depressed portions, which are curved toward a direction in which the first and second through holes are punched to sink downward in the form of funnel as they approach peripheries of the first and second through holes and which are formed at peripheral portions around the first and second through holes that are formed in the target plate material in such a manner that peripheral portions around the first and second through holes in the target plate material are pushed in toward a deeper side in a thickness direction of the base against an elastic force of the base and are deformed, when the target plate material is punched with the punch.

10. The punching plate according to claim 9, wherein the number of the first through holes formed is different from the number of the second through holes formed.

11. The punching plate according to claim 9, wherein a direction in which a depressed portion of the at least one first through hole is depressed and a direction in which a depressed portion of the at least one second through hole is depressed are opposite from each other.

12. A punching plate that is obtained by forming through holes in a target plate material, the through holes comprising:
at least one through hole of which a peripheral portion has a funnel-shaped depressed portion that is curved as it approaches a periphery of the at least one first through hole; and
at least one second through hole of which a peripheral portion has a funnel-shaped depressed portion that is curved as it approaches a periphery of the at least one second through hole, wherein
a direction in which the depressed portion of the at least one first through hole is depressed and a direction in which the depressed portion of the at least one second through hole is depressed is opposite from each other.

13. A liquid ejecting head that has a series of liquid flow passage that extends from a liquid supply source to a nozzle opening, wherein the liquid ejecting head ejects liquid from the nozzle opening by driving a pressure generating source, the liquid ejecting head comprising:
a filter in which a plurality of through holes are formed by means of the pressing method according to claim 1 and which is arranged along the liquid flow passage, wherein liquid that flows in the liquid flow passage is filtered by the filter.

14. A liquid ejecting head that has a series of liquid flow passage that extends from a liquid supply source to a nozzle opening, wherein the liquid ejecting head ejects liquid from the nozzle opening by driving a pressure generating source, the liquid ejecting head comprising:
the punching plate according to claim 9, the punching plate being arranged as a filter along the liquid flow passage, wherein liquid that flows in the liquid flow passage is filtered by the filter.
